(19) United States
(12) Patent Application Publication
(10) Pub. No.: US 2026/0241818 A1
(43) Pub. Date: Aug. 20, 2026

(54) A photovoltaic apparatus for and method of charging an electric vehicle (EV) or battery thereof

(71) Applicant: Maurice Briggs, Norwich (GB)

(72) Inventor: Maurice Briggs, Norwich (GB)

(21) Appl. No.: 19/159,315

(22) PCT Filed: Feb. 23, 2024
(86) PCT No.: PCT/IB2024/051779

§ 371 Date: Aug. 24, 2025

(30) Foreign Application Priority Data
Feb. 23, 2023 (GB) 2302580.2

(51) Int. Cl. B60L 53/30; B60L 53/14; B60L 53/51; B60L 53/80; E04H 6/42; H02J 7/35; H02S 20/21

(52) U.S. Cl. CPC B60L 53/305; B60L 53/51; B60L 53/80; E04H 6/42; H02J 7/35; H02S 20/21; B60L 53/14; B60L 2200/12; B60L 2200/24

(57) ABSTRACT

A charging station comprising a structure or enclosure for charging batteries of an EV vehicle whether said batteries are removed from an EV for a charging cycle or where the EV is coupling directly to charging point. The invention provides for the accommodation or storage of electric vehicles (EVs) or batteries used therein to facilitate charging thereof via means for charging battery cells of an electric vehicle (EV) utilising power predominantly derived from solar radiation via photovoltaic panels or PV arrays. Embodiments include charging stations for electric vehicles (EVs), particularly bikes and scooters. There is further described methods of forming a charging station having multiple access doors through which batteries for an EV or an EV can be coupled to a charging port. In a preferred construction, a standalone charging station for EV scooters provides means for mounting and storing the scooters during a charging cycle. A municipal scooter hiring system is also disclosed.

### FIELD OF THE INVENTION

The present invention relates to the design and installation of a charging station for charging batteries of an electric vehicle (EV) utilising predominantly or exclusively energy accumulated via photovoltaic (PV) panels mounted to or forming the major part of a structure or enclosure.

The invention particularly relates to the provision of a structure or enclosure for charging batteries of an EV vehicle whether said batteries are removed from an EV for a charging cycle or where the EV is coupling directly to charging point within the structure or enclosure and most particularly to the accommodation, securing or storage of electric vehicles (EVs) or batteries used therein to facilitate charging thereof utilising power predominantly derived from solar radiation via PV panels or arrays thereof.

The invention relates most particularly a self-powered, self-supporting charging station for batteries for electric vehicles (EVs), particularly single person EVs such as electric motorcycles, bicycles and foot scooters.

The invention yet further relates methods for charging and storing batteries for EVs and for accommodation, securing and/or storage of EVs, most particularly single person EVs.

The invention additionally relates to an optimised PV power generator on which PV panels operably form the major vertical faces thereof to optimise the harvesting of solar radiation in sub-optimal conditions with respect to diurnal and seasonal variances of direct and indirect incidence of solar radiation, the generator being particularly suited for remote and/or culturally sensitive sites where mains supply is unavailable or where solar energy is unreliable or highly variable.

The invention teaches an off-grid solar powered generator that provides consistent rated power in locations having high seasonal variance of solar energy, for example, in all latitudes of the United Kingdom (UK) in all seasons which does not necessitate a supplementary energy generation source and, in a second aspect relates to a hybrid grid generator which is connectable to additional power generators of the invention, supplementary power sources and/or mains power for regional or national grid infrastructure. Mainland UK lies between the latitudes of 50° N and 59° N and experiences a significant variance in the average angle of incidence of solar radiation between summer and winter. There are many other countries sharing similar northerly latitudes (including a major part of Canada, Northern Europe and a large swathe of the Russian Federation), however, only the southern tips of Chile and Argentina have notable population centres in the corresponding southern latitudes.

The invention presents also an enclosure or unitary structure that is weatherproof, robust, easily maintained and is deployable or transportable to remote and off-grid locations to provide a useful daily power output in sub-optimal conditions, specifically during the months of lowest average harvestable solar radiation.

The invention yet further relates to a charging station for electric vehicles (EVs) suitable for use where connection to mains electrical power is inconvenient, expensive or disruptive to high traffic locations and sites of significant cultural or natural significance.

The terms “generator unit” and “unitary structure” as used herein are directed primarily to an enclosure or closed cabinet within which control circuitry is secured and protected against weather and interference by the curious. The term extends also structures adapted to support solar/photovoltaic panels and adapted to connect to ancillary sources of power, such as accumulator batteries, motor generators, wind turbine, amongst others, and, of course, the mains grid. The scope of the invention, however, is not intended to be so limiting and should be taken to include any ruggedised enclosure adapted to be deployed to remote locations and hoisted or otherwise elevated during its positioning at or recovery from a site. This is particularly relevant where the deployment or recover weight may be significant more than that of the unit when empty and applies equally to enclosures housing battery packs.

The terms “enclosure” and “cabinet” as used herein are intended to indicate a unit or construction made as a unitary power generator and which is adapted to be coupled to ancillary power sources and additional units (which may be formed into a bank or array). Although the term “useful quantities” is used with reference to a desired daily power output from the generator unit during seasonal minima of solar radiation (November, December and January in northern latitudes), no limitation ought to be placed on the rated power of the apparatus as a whole which can be connected to and have its power output augmented by additional generator units or external sources, including mains power. Furthermore, the term “useful quantities” has specific meaning within different contexts as will be described hereinbelow with reference to the numerous uses to which the generator apparatus may be applied.

### BACKGROUND TO THE INVENTION

There are numerous methodologies and technologies utilised for extracting energy from the sun, each having their respective advantages and disadvantages depending on the application to which they are put and factors ranging from environmental impact to capital and maintenance costs.

One of the areas where most technological improvement has been made is in the sphere of harvesting, storing and distributing solar energy, collected via photovoltaic (PV) cells, most often arranged in banks of interconnected cells to form modules, with multiple modules making up a “solar panel”.

With exposure to nominal illumination by sunlight, each PV cell is capable of producing approximately 0.6V and when combined within a 72-cell panel is capable of yielding 300 W. Thus, a modular panel can deliver useful amounts of electrical energy in direct sunlight. This has become the de facto implementation for domestic roof-mounted systems and for commercial and large-scale “solar farms” comprising an array of ground-mounted panels for producing power for commercial enterprises from farms to data centres and for connection to national or regional grid power systems.

The factors regarding the harvesting of solar photovoltaic power referenced in more details below are different for commercial and large-scale implementation than for domestic and remote-site (or “off-grid”) implementations and it is in this latter area that the present invention is particularly concerned.

Capital cost of PV modules and panels has reduced markedly in recent years with the industrialization of printed PV cell technology and the ready availability of modules with integrated DC-DC converters and microinverters. With the reduction in the cost of harvesting solar energy and the need for a near constant supply of energy in off-grid and domestic applications (even at low or nominal levels), particularly where the cost of supplied energy may be prohibitive, focus must now be brought to the storage of generated energy.

Insolation is the term given to the amount of radiation or exposure at certain locations, however, in terms of harvesting solar energy, there are numerous factors at play. Of most significance is seasonal variation at particular latitudes where the intensity of solar radiation even at seasonal maximum is insufficient to provide useable levels of electrical power and additional sources must be utilised.

For any given latitude, an average or optimal panel angle may be calculated, however, with any selected angle towards the vertical there are factors to be considered such as structural strength to resist incident wind forces. Similarly, structural strength must also to be considered at panel angles towards the horizontal where snow loading becomes important. Obviously, a covering of snow severely impacts the harvesting of solar radiation. In less severe conditions, the settling of dust or debris on the panels means that panels require regular cleaning to maintain optimal harvesting.

It is well-established practise to align solar panels to an azimuth corresponding to a particular latitude or to select different azimuths in chosen panels in a solar array to account for seasonal variations.

The prior art is replete with structures and arrangements for tracking in the path of the sun to optimise the incidence of solar radiation on the receiving surface of the PV cells, however, irrespective of whether single-axis tracking is employed (for example, diurnal tracking) or dual-axis tracking following both diurnal and seasonal variations, all are at significant additional cost and inherent complexity. For remote transportable or at least moveable PV generators, robustness and service longevity is a must.

As will be readily appreciate from the patent literature, there are many different approaches taken to solving some of the technical disadvantages. Each area presents specific concerns, however, many aspects are common and will be addressed hereinafter.

Chinese Patent Publication No. CN 107733067 to XIAOGAN QILE CREATIVE DESIGN CO LTD describes a solar charging shed comprising a structure (which may be used as a parking garage/shed for a vehicle) having support pillars for a roof-mounted solar panel and a side wall solar panel. The panels are connected to a battery pack which includes a current stabilizing device on which a charging interface is arranged. The shed facilitates the storage of solar energy within the battery bank for use charging the vehicle.

UK Patent Application Publication No. GB 2 574 373 to SOLIVUS LIMITED relates to a solar charging assembly (whether as an array or a stand-alone structure) comprising at least one structure formed to resemble a tree in which a plurality of solar cells is connected to branches which connect to a trunk portion. A storage battery may be placed within the trunk or underground beneath the structure. A charging station (outlet port) is connected to the or each battery for charging an electric vehicle (EV).

It is an object of the present invention to seek to alleviate the disadvantages of the prior art arrangements and to provide charging station comprising a structure or enclosure for charging batteries of an EV vehicle whether said batteries are removed from an EV for a charging cycle or where the EV is coupling directly to charging point.

It is a primary object of the present invention to provide means for charging battery cells of an electric vehicle (EV) utilising power predominantly derived from solar radiation via photovoltaic (PV) panels.

It is a further object of the present invention to provide a structure or enclosure for the accommodation, securing or storage of electric vehicles (EVs) or batteries used therein to facilitate charging thereof utilising power predominantly derived from solar radiation via photovoltaic panels or PV arrays.

It is a yet further object of the invention to provide a self-powered, self-supporting charging station for batteries for electric vehicles (EVs), particularly single person EVs such as electric motorcycles, bicycles and foot scooters.

It is a yet further object of the invention to provide a means and methods for charging and storing batteries for EVs and for accommodation, securing and/or storage of EVs, most particularly single person EVs.

### SUMMARY OF THE INVENTION

The present invention provides a photovoltaic (PV) charging station for charging electric vehicle (EV) batteries, the charging station comprising:
an enclosure having structural frame elements and a ground-engaging element attached thereto;
a plurality of PV panels secured to the frame elements;
sealingly disposed within the enclosure control circuitry for regulating the electrical energy generated via the PV panels and energy accumulators connected control circuitry; and
a charge coupling,
in which at least two of the PV panels are disposed in a vertical plane and comprise outward faces of the enclosure.

Preferably, the PV panels are integrally with the frame elements.

Advantageously, the enclosure includes wall sections and a roof section to which PV panels are secured.

Preferably, the enclosure has a box-like form in which structural frame components provide the peripheral corners thereof and the PV panels are secured therebetween. Conveniently, each wall section comprises a framed PV panel disposed in a vertical orientation presented as the outward facing surfaces of the enclosure.

The total surface area of PV panel is optimised to generate a daily average power generation of at least 200 Wh.

In one construction, the enclosure includes multiple receptacles for removable EV batteries, each receptacle having a charge coupling for connecting to the terminals of the EV battery.

In an alternative construction, the station is adapted to provide means for directly charging an electric vehicle (EV).

Advantageously, the generator apparatus includes within the structure or enclosure accommodation, securing or storage space for at least one EV.

In a yet further alternative construction, the structure or enclosure is a building having a plurality of receiving bays for EVs.

Preferably, the charging station includes mounting means for at least one EV.

In a construction designated for municipal use, the charging station includes a communications module.

Conveniently, the charging station includes payment verification means.

In a further construction, the structural frame elements define an octagonal enclosure between which PV panels are disposed to present eight solar harvesting faces, at least one of the faces being hingedly secured to corresponding frame elements to facilitate access to the interior of the enclosure.

Advantageously, the energy accumulators comprise a bank of batteries having deep-cycle characteristics and a bank of batteries having high power delivery characteristics and wherein combining cell technologies with charge controllers and voltage monitoring circuitry optimises both charging and delivery of power in sub-optimal conditions.

In a preferred arrangement, the first battery bank comprising a working bank of frequent and deep cycling cells, having superior weight to kWh ratios and the second battery bank comprising a reserve bank providing additional charging capacity and lower charging temperature capabilities that the working bank cells, each bank having charge balancers to compensate for charge state differences during a charging and discharging cycle.

Advantageously, the first battery bank comprising lithium ion or lithium iron phosphate batteries and the second battery bank comprising Absorbent Glass Mat (AGM) cells, each provided in a configuration associated with the required system voltage.

The present invention relates also to a method of charging the battery of an electric vehicle (EV), the method including:
accessing a charging receptacle mounting point for the EV battery within the enclosure of a charging station of the type described hereinabove;
mounting the EV battery within the charging receptacle and aligning battery
terminals of the battery to a charge coupling to the mounting point;
connecting a charge coupling to the EV battery terminals to an electrical charging means;
attending to a charging cycle; and;
verifying the ev is ready for re-use.

The present invention further relates to a method of charging an electric vehicle (EV) battery, the method including:
accessing a mounting point for the EV within the enclosure of a charging station of the type described hereinabove;
mounting the EV to the mounting point;
coupling the EV to an electrical charging means;
attending to a charging cycle; and;
verifying the EV is ready for re-use.

Advantageously, the mounting point is elevated.

Preferably, the charging cycle includes payment verification steps.

Conveniently the method includes storing the EV.

### BRIEF DESCRIPTION OF THE DRAWINGS

The present invention will now be described more particularly with reference to the accompanying drawings which show, by way of example only, exemplifying embodiments of charging station for charging batteries of an electric vehicle (EV), together with constructions of self-supporting and anchored electric vehicle (EV) charging stations in accordance with the invention. In the drawings:

FIG. 1a is a diagrammatic illustration of the path of the sun in the UK at both the winter and summer equinox (solstice) and the corresponding optimum angle for the position of solar panels;

FIG. 1b is a bar chart showing the average levels of direct and indirect solar radiation that is usable by solar panels for each month of the year at a latitude corresponding to London, United Kingdom (51.5° N);

FIG. 2is a perspective elevation of a first embodiment of charging station in accordance with the invention having a PV panel located on each external face of the cabinet;

FIG. 3 is a schematic illustration of components of control circuitry housed within the cabinet or enclosure;

FIGS. 4a and 4b are an angled side view and a perspective elevation respectively of an enhanced construction of the first embodiment of charging station having a PV panel located on each external face of the cabinet;

FIG. 4c is an exposed perspective elevation similar to that of FIG. 4b in which accumulator cells and control circuitry is disposed in an alternative configuration ;

FIGS. 4d and 4e are perspective elevations of a further construction of the first embodiment of charging station having a substantially equal PV panel area presented on each external face of the cabinet (each face being provided with a MPPT);

FIGS. 5a and 5b are a detailed side view and a perspective elevation of a construction of charging station similar to that shown in FIGS. 4d and 4e having a pivotable roof section to present a combined landing and charging platform for an autonomous electric vehicle (drone);

FIGS. 6a to 6c are perspective elevations of various constructions of framed PV panel;

FIGS. 7a and 7b are perspective elevations of a second embodiment of charging station in accordance with the invention;

FIGS. 8a and 8b are perspective elevations of a third embodiment of charging station in accordance with the invention having a PV panel located on each exposed face of the cabinet;

FIG. 9 is a perspective elevation of a variant of the first embodiment of charging station having a plurality of securable receiving receptables for removeable EV batteries;

FIG. 10a is a perspective elevation of a fourth embodiment of charging station comprising a structural frame on which PV panels are fixed and within which a battery bank and control electronics are sealingly secured;

FIGS. 10b and 10c are perspective elevations of hinge details of at least one frame panel adapted to facilitate access to the interior of the embodiment illustrated in FIG. 10a; and

FIGS. 11a to 11c are perspective elevations of a specific construction of the fourth embodiment of charging station adapted as a storage enclosure for foldable electric kick scooters.

### DETAILED DESCRIPTION OF THE DRAWINGS

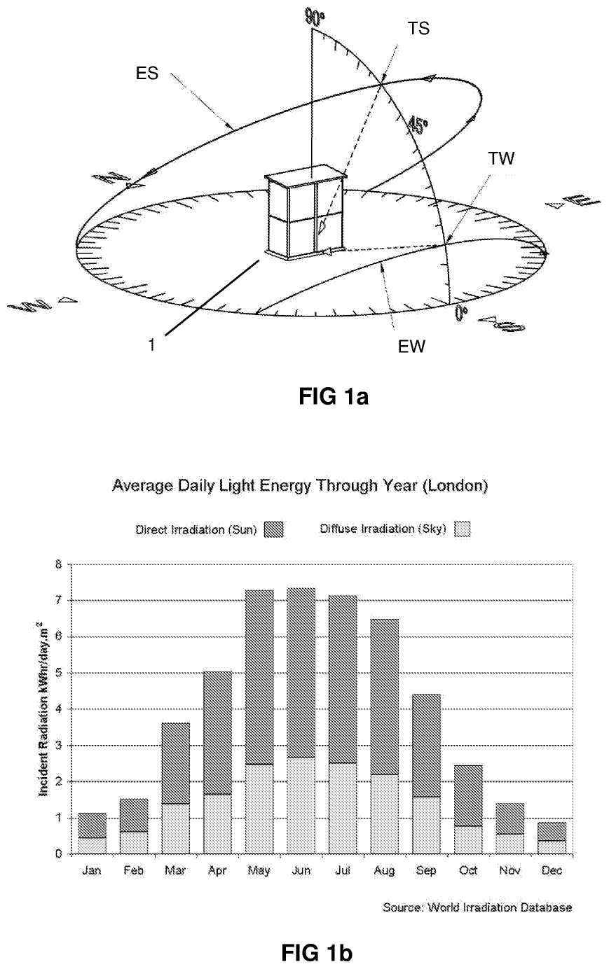

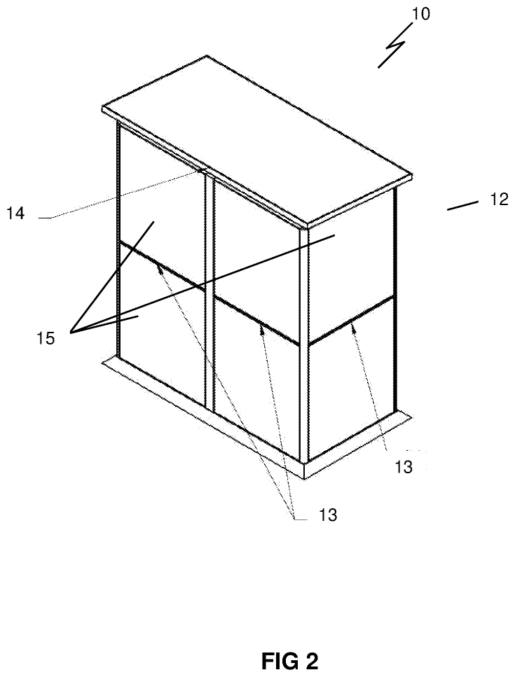

Referring to the drawings and initially to FIG. 1 which shows, as exemplifying of the prior art, a power generator assembly for supplying electrical energy for a smallholding or isolated domestic dwelling and comprises an array of solar panels (a) set out as three banks connected in daisy-chain configuration via cable connectors (b). The panels are fixed at a tilt angle corresponding to the site latitude and face in a southerly direction for northern hemisphere sites. To augment the input from the solar panels (and provide additional power during the hours of darkness), a wind turbine (c) is provided. For larger power generation plants, turbines operating at medium and high voltages provide solutions with lower cost per installed kW whereas the cost of small wind turbines (SWTs) are often two to four times more costly per installed kW due to the relative immaturity of the SWT market. Many “micro wind” installations, that is, those having a rotor swept area of less than 40 m² have a rated power of between 1 kW and 7 kW. A 6 kW turbine is capable of generating up to 9000 kWh annually.

A typical domestic home uses approximately 11,000 kWh of electricity annually which equates to approximately 30 kWh daily consumption.

The direct current (DC) outputs of the PV panels (a) and wind turbine (b) may be routed through a fixed power output junction box (d) to a battery bank housed within an enclosure (e) within which voltage regulators, monitoring and control electronics is also housed in a weatherproof cabinet. Power inverters may also be found within the enclosure (e) or optionally within the junction box (d) where a power feed (f) couples the power generation assembly to the demand. Mounted on a pole attached to the enclosure a supplementary PV panel (g) for the control electronics is provided.

As noted in the preamble, configurations of PV arrays and devices for charging electric vehicles of the prior art do not readily lend themselves to small domestic or off-grid applications and are unsuitable for power hubs for charging electric vehicles in a majority of circumstances.

As detailed hereinabove, there are notable diurnal and seasonal variances in the angle of incidence of direct solar radiation on a surface. The primary diurnal influence is the arc made by the sun (with respect to incident surface, that is, a static PV panel) during the course of the day between sunrise and sunset. Additional diurnal variances include cloud cover and shadows from adjacent vegetation or structures (such as buildings but may include other PV panels in an array). The tracking of the sun's arc using an automated tracking mechanism to retain the plane of the PV panel perpendicular to the sun overcomes much but not all of the diurnal variances but add significant overheads to the harvesting of electrical power. For -13-static PV panels, to maximise the collection of incidental radiation they should face directly south in northerly latitudes and north in southerly latitudes, that is, positioned in an east-west plane.

To account for seasonal variances, the angles to which the PV panels are tilted depends on the latitude of the site. In FIG. 1a, an enclosure 1 representing a charging station of the invention is centrally disposed within a circle on which the four cardinal directions N, S, E, W are indicated. A first line ES indicates the elevation of the daily path of the sun at the summer equinox and represents the optimal pitch or tilt TS of a PV panel to collect the maximum available solar radiation at that time of year. Similarly, a second line EW indicates the significantly lower elevation of the sun's path at the winter equinox but represents nonetheless the optimal tilt TW a PV panel to harvest solar radiation at that time of year. For a static PV panel, it is likely that the optimal tilt angle will be represented by the median of the two extremes (represented by the lines ES, EW and their corresponding tilt angles TE, TW) which will be closely aligned to the vernal and autumnal equinoxes.

In calculating the available energy that can be harvested from solar radiation it is important to distinguish between “direct irradiation” where a panel is collecting light from the sun and “diffused irradiation” where a panel is collecting light energy that has been scattered primarily by clouds or reflected/ambient light. In FIG. 1b, a bar graph showing both the direct and diffuse monthly radiation averages each month of the year at a location 51° N (London UK) measured as the average daily kilowatt hour energy incident per meter squared (kWh/day·m²). From this example, the average daily direct light available will generate approximately 0.5 kWh to 0.75 kWh of energy per meter squared of exposed PB panel during the months of November, December and January. Furthermore, the ambient or diffuse average does not exceed 1 kWh per meter squared of available PV panel for any period between October and February.

It is possible to take the combined daily average of the direct and indirect (ambient, diffuse or reflected) illumination and calculate a minimum area of PV panel required to achieve a nominal rating for an array or assembly of PV panels.

Referring now to FIG. 2, a first embodiment of charging station 10 is shown and comprises a cabinet 12 defining an enclosure and having four planar faces 13 and a roof section 14.

In its most basic iteration, the charging station comprises a cabinet to which vertically disposed PV panels 15 have been fixed to the front, rear and side faces, the front being a southerly facing surface in northern latitudes and has a total area of receiving PV panel to provide the rated output. For low output requirements, average daily winter output may be as little as 200 Wh which may be sufficiently to charge many electronic devices or, in one highly specific application of the invention, is used to maintain an operational current for recording, storing and transmission of collected data at a remote monitoring stations. The energy harvested may be augmented by the placement of reflectors angularly deflecting direct incident light towards the receiving panels. In a preferred construction, the roof 14 comprises a PV panel which may be pitched to optimise harvesting of solar radiation and/or prevent accumulation of snow and leaves thereon.

In a modified orientation of an enclosure having a rectangular cross-section, the front face is directed eastwardly towards the rising sun and the rear face is disposed towards the setting sun to maximise the area of incidence during the winter months and allow the southerly facing side and roof panel to collect the available light during the daily maxima.

The cabinet forms an enclosure for energy accumulation via storage battery banks and energy management or control circuitry. In the basic embodiment illustrated in FIG. 2, there are seven PV panels 15 disposed across five faces (two sides, front, rear and roof).

The PV panels are designed and rated to withstand harsh environmental conditions. In the case of a cabinet formed of extruded or profiled aluminium frame components, the resulting enclosure will have good corrosion resistance characteristics and be able to withstand heat and UV extremes. Anodized stainless steel is a preferred material for the production of an enclosure in which the panels are secured to an existing face via attachment of a border frame.

A number of environmental management features are integrated to allow the cabinet to exist within potentially quite extreme outdoor settings.

Discrete vents, protected internally by a fine internal mesh (to prevent insect ingress) are either built in to the roof frame or below the roof panel to allow hot air and any gas generated from charging the batteries to escape. Equivalent vents can be placed in the base or in the support floor to allow ingress of cool air to circulate. This feature can be supplemented with an automated and temperature-triggered waterproof cooling fan to improve the flow of air from base to top. Where there is a likelihood of operational temperatures exceeding thermal limits for the internal components, a series of fans may be triggered as predetermined thresholds are reached. An additional optional feature directs a flow of air across the PV panels to reduce surface temperature to minimise negative temperature coefficients where power generation of the PV panels may be reduced beyond that utilised by cooling fans.

An earth rod (not shown) can be placed before installation of the enclosure and connected to the frame components to allow the enclosure and equipment within to be electrically earthed, with connections from the cabinet and internal frame provided. Where ground screws are used to secure the cabinet, these may be used as part of earthing the charging station.

In the case of cabinets deployed to more extreme low-temperature environments, fluted corrugated plastic sheet in isolation or in combination with a commercial insulation material can be used to reduce temperature extremes within the cabinet, allowing the equipment and cells more operational range within their design parameters. An air gap between the external panel face and frame components may also be provided to prevent thermal bridging.

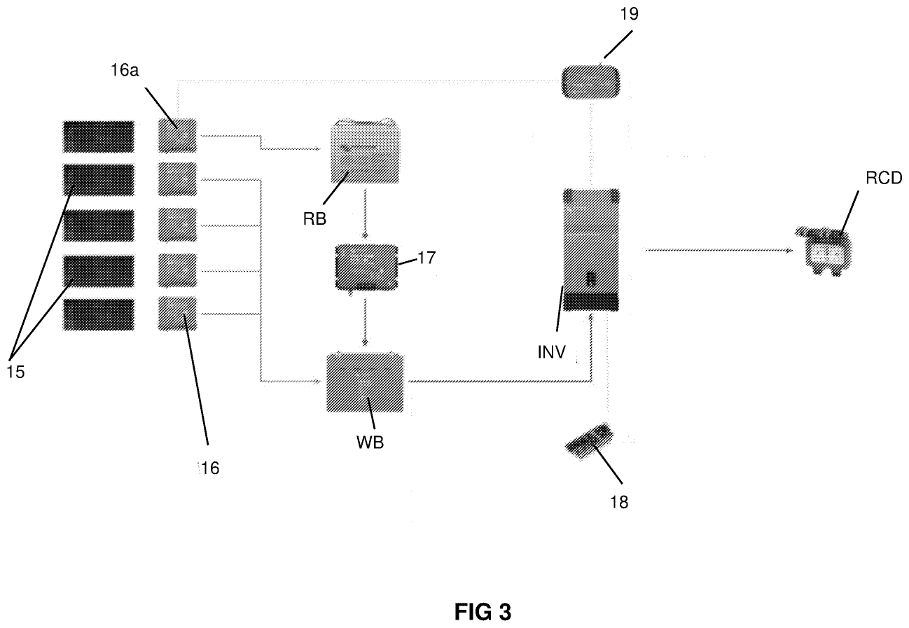

As illustrated in FIG. 3, the seven 100W PV panels (only five are shown) are connected to charge controllers 16 for each face so as to regulate the charge current provided to the battery cells. In the exemplary construction, one of the charge controllers 16a (associated with one PV panel, hereinafter identified as the “top panel”) is connected to a reserve bank RB of deep-cycle batteries of the type described herein and capable of charging below 5C. The remaining four charge controllers 16 channel harvested power from the remaining panels to charge a bank of batteries (designated the “working bank” WB) ideally comprising lithium ion or lithium iron phosphate (LiFePO4) cells both known to have excellent power characteristics. Power converted from DC to AC through a 2 kW inverter INV provides mains voltage via a breaker RCD or selected voltages optimised for the recharging of EV batteries or EV directly connected to the inverter output . . .

The reserve bank RB powers an isolated DC to DC charger 17 which maintains an operating voltage across the individual batteries of the working bank WB. The DC to DC charger 17 is a 30 A unit designed to charge the working bank WB if individual battery voltages drop below 12.5V when the reserve bank battery voltages are over 11V.

Associated with the inverter is an actuation sensor 18 which enables a lower power standby mode. A remote monitoring unit 19 measures working and reserve battery voltages and inverter load and may include a communications module for alerting the user or a maintenance contractor.

It has been noted that with solar panels 15 feeding multiple charge controllers 16, where the PV panels each perform differently on each face with both diurnal and seasonal variations, an opportunity is presented to combine cell technologies to leverage their respective strengths and compensate for their respective weaknesses. By combining cell technologies within a generator circuit of the kind presented by the invention, it is possible to increase the longevity of both cell technologies and this is especially relevant with frequent cycling or frequent load applied particularly through the summer months.

Advantageously, the working bank WB comprises lithium ion or lithium iron phosphate cell batteries connected together in series to create the required circuit voltage (for example, two 12V batteries to present a 24V circuit). Further batteries may be connected in parallel to provide additional capacity to the working bank where required. A charge balancer can be used to ensure that charge state differences between the cells are compensated for during the charging process.

In a preferred configuration, as detailed hereinafter, each face of the charging station is optimised to feed a 48V battery pack within a battery bank, whereby PV panel voltages at full insolation generate open-circuit voltages of 60V and an approximate voltage of 51V under load, that is, the charging voltage for the respective battery packs.

Commercially available lithium ion and lithium iron phosphate cell batteries often feature in-built protection circuitry, cycle more deeply and more frequently than alternative technologies and have more favourable weight to kWh ratios compared to alternative technologies.

It is noted, however, that these batteries can over time degrade between charge states of 80% and 100%, is expensive per Wh compared to other battery technologies and has poor charging characteristics below 5C.

Absorbent Glass Mat (AGM) cells making up the reserve bank RB are connected together in series to create up to a 48V circuit. The AGM batteries may also be connected in parallel to create additional capacity where required but with a limit of 3 parallel batteries per bank. A charge balancer is always used to ensure that charge state differences between the batteries are compensated for in the charging process. An over-current protection device is installed on the circuit to compensate for the lack of in-built protection features.

It is noted that AGM batteries do not tend to degrade with charge states of 100% over longer periods of time (as compared to lithium-base batteries), are inexpensive per kWh of capacity compared to other technologies, can charge at temperatures below OC and have deep discharge characteristics where they are capable of discharging up to 40% of their capacity daily for over 1,000 cycles before they start to degrade. In contrast, however, if frequently cycled at rates of more than 40% discharge for periods of over 2 hours, the battery cells can degrade more rapidly. It is also during winter minima that the lowest temperatures are likely to be experienced so it is crucial to focus charging on the batteries having the lowest operational temperature range.

It will be appreciated by the skilled addressee that, as battery technologies improve and operating and charging characteristics allow for better performance, the exemplar figures provided above may change.

As shown in FIG. 3, the working bank WB of lithium-based batteries are charged directly from the charge controllers 16 with the exception of the charge controller 16a associated with the top panel which is connected to the reserve bank RB. The panels selected to charge the working bank WB are those which will receive the maximum solar radiation during winter minima and therefore retain as best as possible a bias towards their full charge state.

In the case where there is frequent daily cycling of the AGM reserve bank RB, there is a benefit to adding a lithium-based or alternative frequent cycling or sacrificial battery to charge from the top panel charge controller 16a, directs the majority of the cycling to this battery, reducing the depth of discharge the AGM cells experience and decreasing the time at which the lithium cells sit at a fully charged state. The isolated DC to DC converter (or charger) 17 is used to transfer energy from the lithium batteries of the working bank WB to the AGM batteries of the reserve bank RB and must be sized to charge at a rate that is as close to the rate of discharge of the AGM batteries as is achievable. The voltage drop the working bank WB experience when a load is connected via the inverter INV triggers the charging process from the reserve bank RB which continues until either the working bank batteries are fully charged or the reserve bank is depleted.

This approach reduces cycle depth of the working bank batteries, increasing their longevity whilst decreasing the time the reserve bank spends at 100% charge state, also increasing its longevity. This arrangement also directs stronger summer solar yields from the top panel to the reserve bank batteries allowing them to cycle more often and recover more quickly when solar energy is more abundant, again reducing cycling on the working bank. Advantageously, the solar panels that produce the most yield in winter to charge the bank that actually powers load, need not use energy at solar minima to retain the temperature of the working bank cells within an operational range. The energy overhead to heat the lithium cells to absorb a charge or convert energy via the DC to DC charging process at a time when energy The utilisation of dual cell technologies to optimise harvesting at solar minima provides additional capacity in a given system economically reducing the overall cost of the system without incurring any of the concessions a single cell technology would entail.

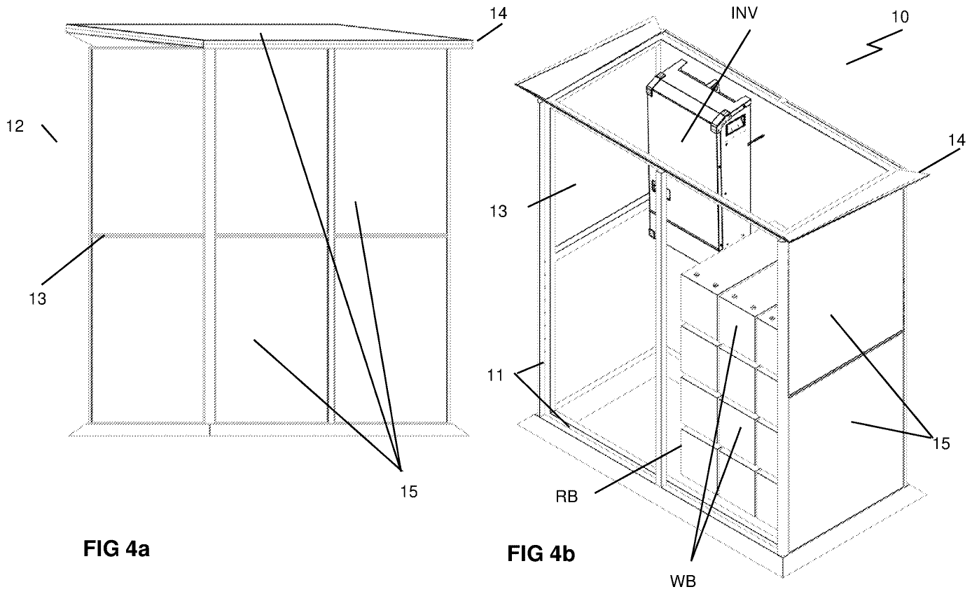

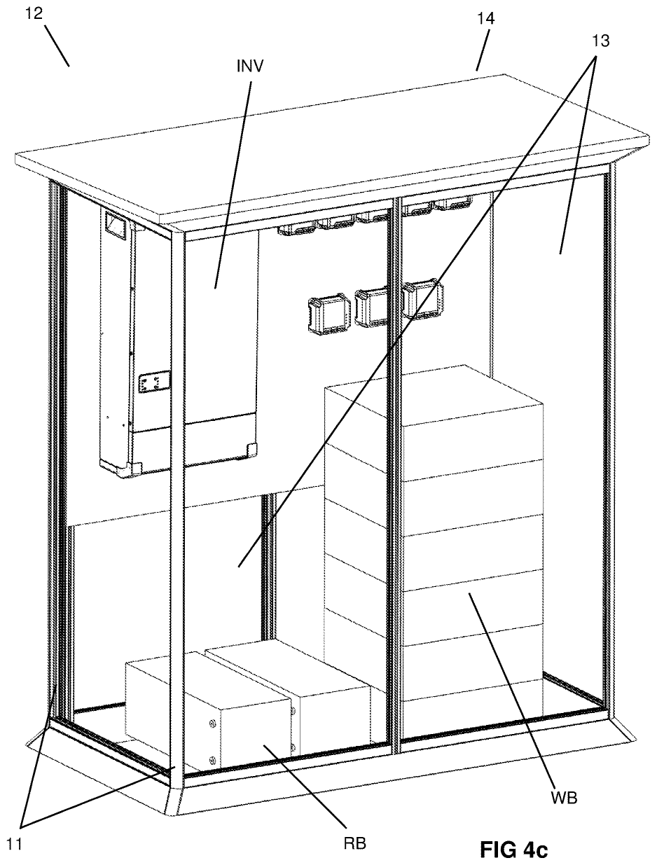

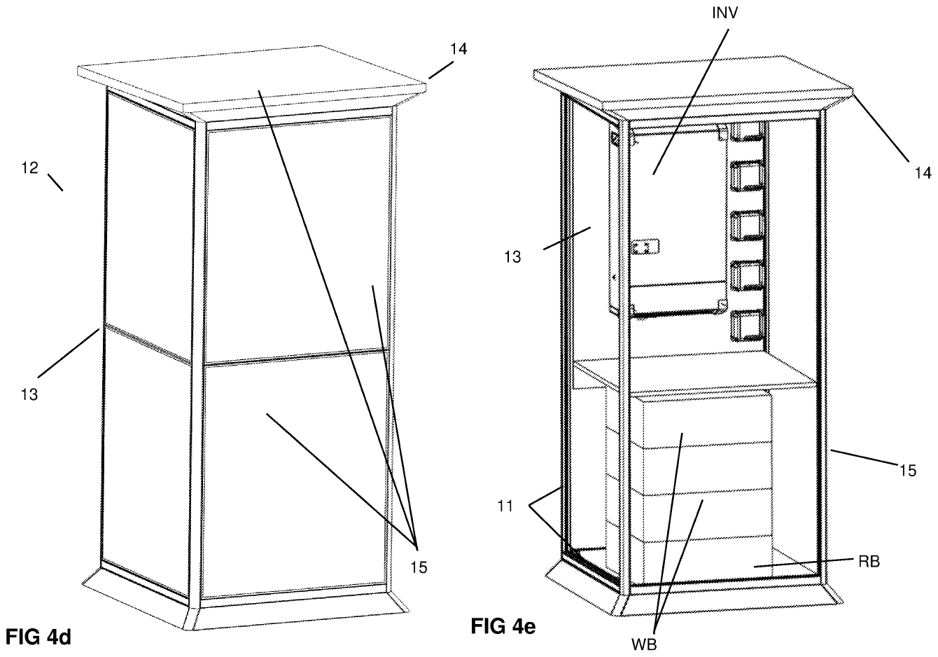

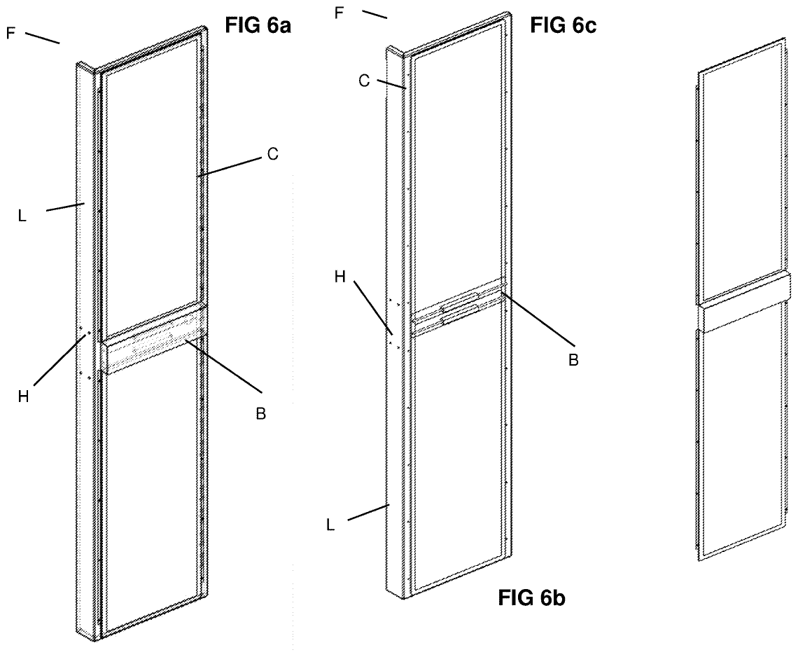

FIGS. 4a and 4b show a cabinet 10 similar to that of FIG. 2 having a larger capacity and an internal structural frame 11. As before, each of the walls 13 has attached to thereto a solar panel 15, ideally mounted with a panel frame (as shown in FIGS. 6a to 6c) which is fixed to structural frame elements 11 of the cabinet 12. A roof section 14 is disposed at an angle with respect to the front or rear face so to optimise solar harvesting ensuring optimal conditions in the summer months.

The cabinet is so sized and shaped as to accommodate standard batteries to form the reserve bank RB and working bank WB. Lithium-based batteries (such as lithium ion or lithium iron phosphate batteries) are used as the working cells and are provided in sufficient quantities to ensure that less than 40% depth of discharge is reached every day during the sub-optimal solar harvesting period (particularly in winter), to maximise cell longevity (each battery lasting anywhere between 25 and 40 years).

Stacking the batteries of the working bank WB and connecting them in a 4S3P configuration (that is, four batteries in series and three in parallel) delivers a maximum storage capacity of 33 kWh and a maximum power output of 15 kW (240 Volts, 60 Amps from 48V, 312 Amps) via the wall-mounted inverter INV.

The embodiment described finds utility in many guises and may be used as a hybrid grid charging cabinet having integrated solar generation.

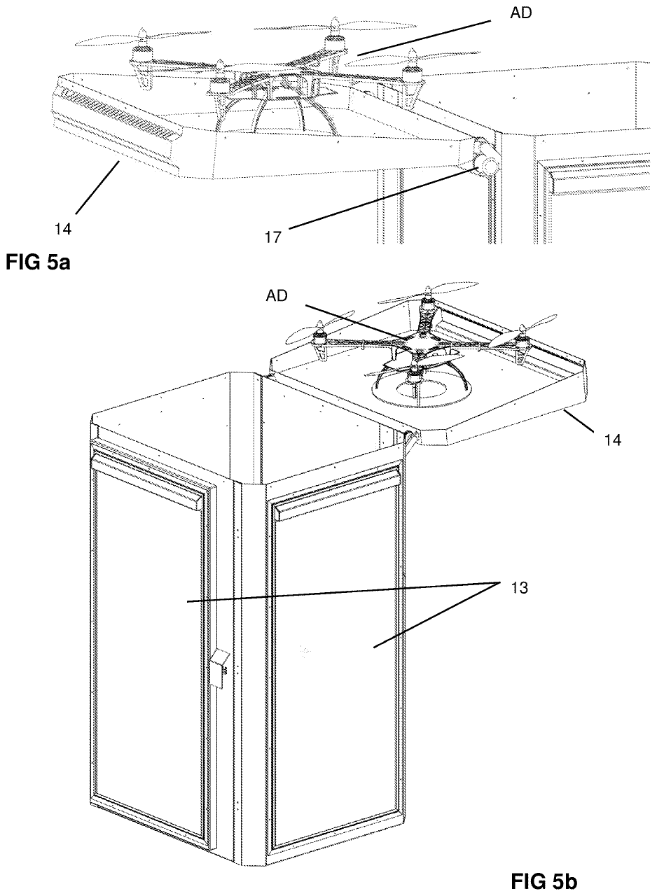

FIG. 5c illustrates a minor but important modification to the arrangement of this embodiment of solar generator enclosure in which the working bank is arranged as a linear stack. In a preferred construction, a standard 19-inch rack structure may be used and selected components, such as lithium battery packs, inverters and charge controller circuits may be packaged for simple demountable connection within a rack.

FIGS. 4d and 4e exemplify a further construction of the first embodiment of charging station enclosure in which the internal frame 11 provides support for standard industrial rack-mounted components, such as rack-mountable lithium packs as noted above. As production is scaled, the availability of reliable, inexpensive and potentially “plug and play” component modules become standardised, power connections including ground connections to the frame elements, will facilitate ready expansion of the capacity of the enclosures of the invention. As noted below, the invention may be provided in a “kit of parts” form, allowing a purchaser to select minimum operating components and to increase capacity, add reserve bank batteries or incorporate external sources of energy, as desired.

In the illustrated embodiments, the charge controllers 16 and the inverter INV are mounted to a back panel (with 10 cm clearance around the inverter), however, these components may be provided as rack-mounted alternatives.

The enclosure may include sheet aluminium or steel panels to which the PV panels are fixed. This facilitates the direct attachment of PV panels to the enclosure. Alternatively, the PV panels are mounted within frames which are then secured to the sheet panels of the enclosure. In the most preferred constructions, PV panels mounted within rigid frames form the front, rear and side faces (and ideally the roof section) of the enclosure.

FIGS. 5a and 5b show a charging station in accordance with the invention where at least one battery for charging is that of an autonomous vehicle such as an aerial drone AD. The roof section 14 of the cabinet is adapted to pivot open around a motor-driven shaft 17. The drone is locked magnetically to the inner side of the roof section from which it may be deployed when release power is applied to disable the magnetic lock. Charging of the drone battery is wireless via inductive coupling. During deployment of the drone, the roof section is closed to avoid shading of the PV panels 13 and allow for further charging via the roof section PV panel where provided.

FIGS. 6a to 6c show panel frame components F for retaining a pair of PV panels. A first construction of panel frame includes a lip region L for mounting the panel to an existing face sheet to the enclosure and fixing holes H through which tamper-proof bolts may be secured. A PV panel cover section C includes a folded box structure B to provide cable routing from the PV panels to the charge controllers 16 within the enclosure.

In the preferred constructions of the first embodiment of the invention, the frame elements 11 comprise extruded profiles of aluminium or steel joined together at 90 degree angle joints to form an outer frame. As noted above, internal racking may be utilised and form part of the structural integrity of the enclosure. Solar panels are sited within a peripheral frame component and attached to it via shelving pins that locate the panels within a recess of the extrusions. This method of assembly allows panels to be installed vertically into a pre-assembled frame.

A base component, such as that illustrated in FIGS. 4a to 4e, may be made from thermoplastic polyurethane (TPU) within which holes are formed to allow the internal frame to be secured thereto to form the core of the internal frame shape. Additionally, there are ground fixing holes to allow the base to be secured to the ground or a concrete slab via appropriately rated bolts. As noted above, ground screws can be used to secure the station cabinet. A vent in the base component allows for air to enter the cabinet from the base and is protected by a mesh to prevent ingress of insects. A water drainage hole with mesh protection may also be provided for water ingress or condensation forming within the cabinet.

The roof section 14 or optional roof PV panel 15 is joined to the internal frame via a TPU form which can be covered separately with external coloured composite aluminium panels to achieve a desired aesthetic.

The inverter INV may be mounted in the top left or right corner of the cabinet with 10 cm or greater clearance around it in all directions. Batteries are stacked vertically in the internal area opposite to the inverter to ensure any escaping gases from the To extract maximum energy from the respective PV panels 15, Maximum Power Point Tracking (MPPT) controllers are provided for each PV panel covered face of the cabinet. The controllers 16 are located above the batteries on a fire-resistant backboard. Circuitry, such as a monitoring unit 19, balance the charge rate of the batteries may also be located on the backboard.

Brushless motor driven DC fans are installed within the roof TPU form component of the cabinet. Fans in combination with vents to the base and in the top of the cabinet ensure air can flow rapidly if required from the base of the cabinet to the top and atmosphere to keep internal equipment cool. The fans are triggered by a temperature sensor with a pre-set threshold.

A central LED light strip can be used to indicate visually the current status of the cells within the cabinet, their capacity level and their charge or discharge level, as well as provide a visual alert to users of any issues that may need investigating.

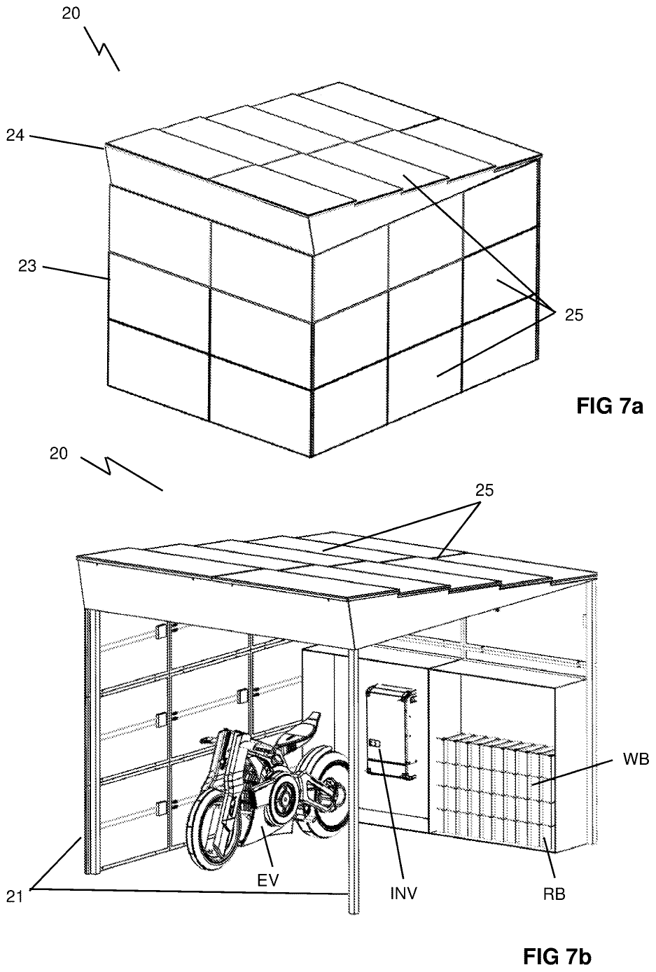

Referring now to FIGS. 7a and 7b which show a garden shed or small garage structure 20 having structural frame elements 21, front, rear and side walls 23 and a sloping roof section 24. Each wall is covered with PV panels 25 which are either fixed to existing walls or are mounted within frames which are secured together and along their peripheral edges to the frame elements 21 of the enclosure. One wall may include a door (not shown) or be formed as a complete hinged section.

The roof section 24 is shown as a pitched shingle style construction where the PV panels 25 substitute the shingle tiles, however, a single sheet roof may also be provided to which the PV panels are fixed. As before, the pitched angle of the roof is determined by individual or site requirements and may be oriented towards the summer sun at its diurnal peak. In the exposed view of FIG. 7b, a front wall (or door) and a side wall 13 have been detached to expose the interior layout in which a bank of batteries WB, RB, connected in a configuration similar to that discussed with respect to FIG. 5 or FIG. 6b are disposed along a rear wall together with the associated inverter INV and control circuitry. Electrical outlets may be provided for illumination both inside and outside the enclosure and for charging points for electric vehicles EV from scooters and electric bikes to electric motorbikes (as illustrated) and cars. A wall mounted reel (not shown) for an EV cable may provide convenient connectivity adjacent the garage.

The solar yield provided by PV panels on the roof section 24 and front, side and rear faces 23 affords a useful quantity of energy to power an inverter INV that can charge an EV at rates over 2 kW using stored energy in the working bank WB.

Panels are optionally joined together via 3D printed joints that secure within the corner of each aluminium frame interior of each solar panel face and have a central hub that bolts them together to form a strong network of connections across the face. These can be optionally hinged to allow the panels on each face to open in a concertina fashion to allow full access to the inside equipment.

Insulation can be installed within the panel apertures to provide an improved stability of temperature within the structure.

The aperture between the angled roof panels and the side and front panels can be lit with an LED light strip to indicate charge status and solar yield via changing colour and patterns.

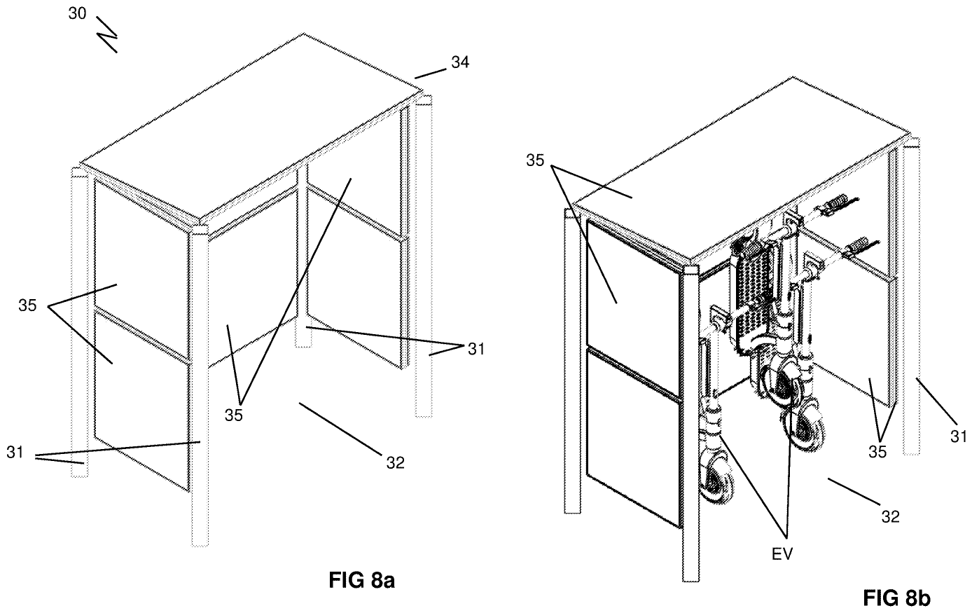

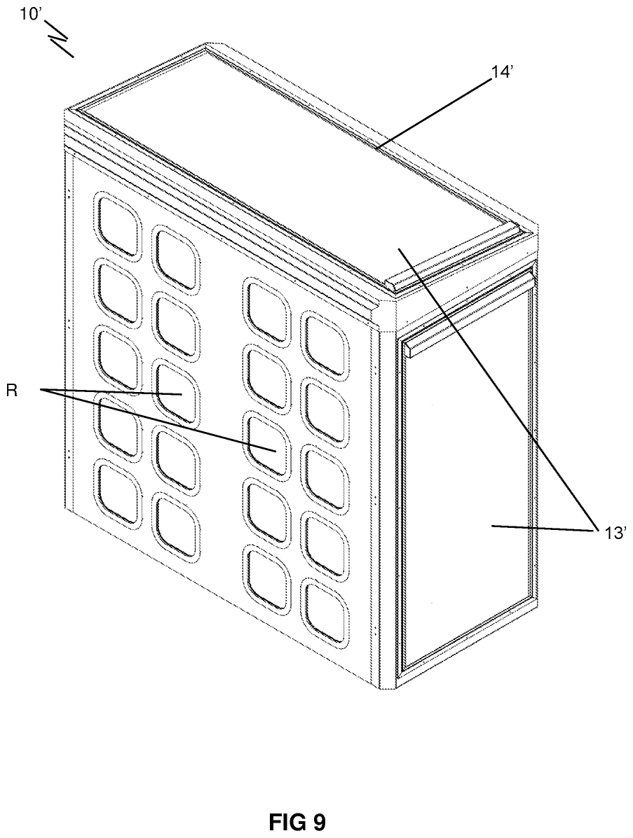

A third embodiment of charging station 30 is illustrated in FIGS. 8a and 8b and is formed to present and open-faced cabinet 32 comprising structural frame elements 31 and a series of PV panels 35 disposed therebetween. As the cabinet is open, diffuse light may be utilised by using double-sided PV panels. Conveniently, panel frames are provided to mount the PV panels back-to-back and may incorporate charge controllers/regulation to manage the mismatched voltages generated by the paired panels and to facilitate fixing of the mounted panels 35 to the structural frame elements 31.

In the construction shown, there are two panels 35 (each double-sided) disposed one above the other on each side wall, a pair of upper and lower panels (which need not be double-sided) on the rear wall adapted to accommodate mounting hooks and charging points for foldable electric scooters EV, as shown in FIG. 8b. Batteries forming the working bank WB and reserve bank RB may be housed within the enclosure at ground level. The use to which the cabinet is applied, that is, as a charging station, obviates the requirement for an inverter. An additional communication module allowing for payment verification may be mounted on the interior rear wall or more conveniently adjacent the open mouth of the cabinet.

A variant of the first embodiment of charging station 10′ is shown in FIG. 9, in which the face presented away from the arc subtended by the sun and thus normally receiving the greater degree of reflected or incident light to the PV panel 13′ is replaced by a face within which a plurality of battery receptacles R are provided. Each receptable is adapted to receive a removeable EV battery, for example, from an electric motorcycle, bicycle or foot scooter. Where the charging station is commissioned by a single manufacturer, the receptacles may include a charge coupling which connects directly to the EV battery. This arrangement facilitates a battery-swap scheme, where a fully charged battery may be retrieved from a receptacle when a receptacle door is released after verification that a valid and rechargeable battery has been deposited and payment verification has been made. In other circumstances, terminal connections may be provided for a range of batteries, however, charging will only commence after the receptable door is closed and, where provided, payment verification has been made. To facilitate card payments, a communications module for verification of payment may be mounted within the cabinet. In a preferred arrangement, battery charging is accelerated for newly deposited batteries and batteries which have been fully charged become part of the working bank WB or reserve bank RB according to predetermined charging criteria.

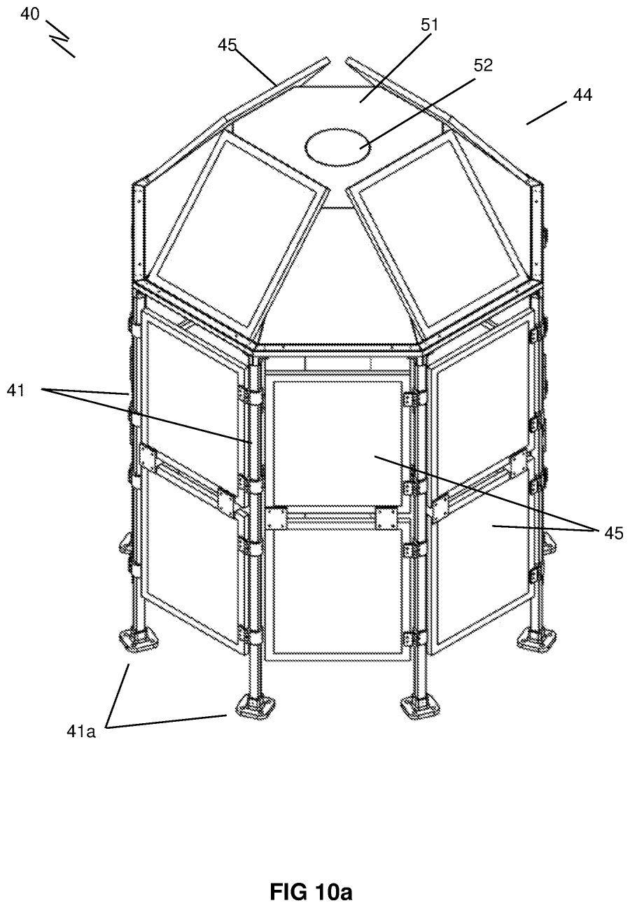

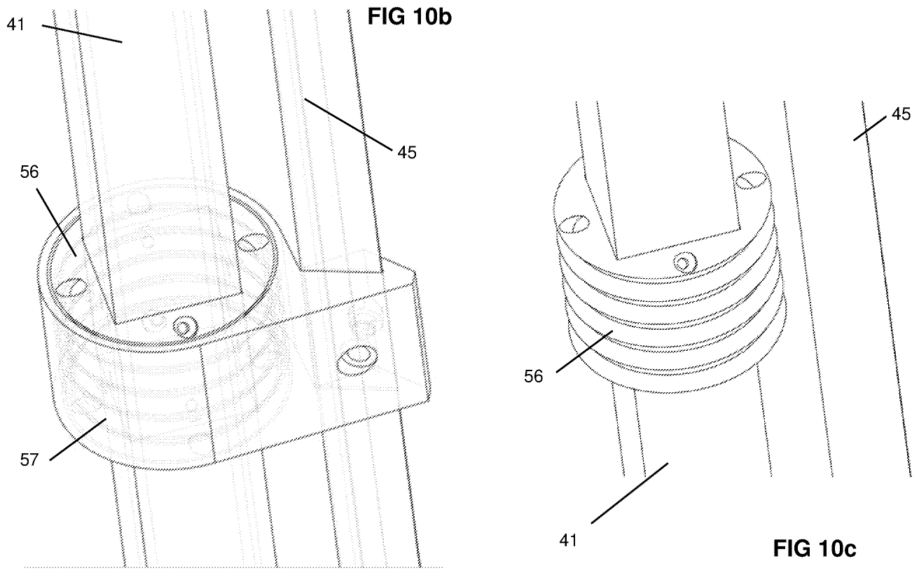

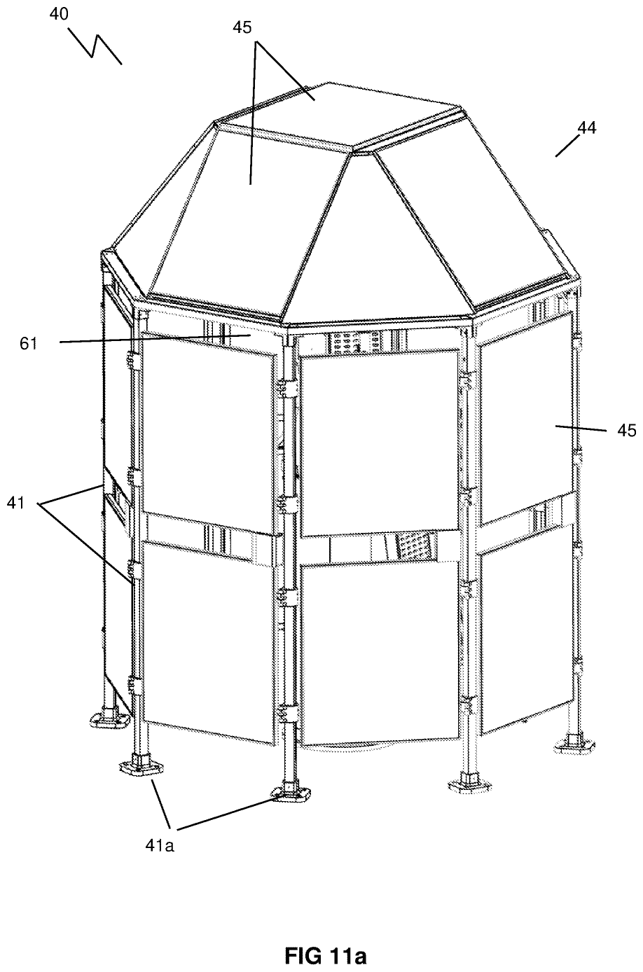

A fourth embodiment of charging station 40 is shown in FIG. 10a and comprises a self-supporting, grounding-engaging structural framework of a substantially octagonal cross-section, having eight upright frame elements 41, to which are attached PV panels 45 in a vertical orientation. The upright frame elements support a roof section 44 on which there are disposed four PV panels 45 angled to optimise solar energy harvesting. The roof section also includes a support plate 51 defining a central aperture 52. -25-Sealingly enclosed within the framework, the reserve and working battery cells, together within the control circuitry are arranged in a configuration determined by the proposed utilisation of the generator. Where the generator is designed as a stand-alone device, feet 41a at the bottom of each upright frame element may be anchored to the ground or to a concrete bed. Where the generator is designed to be lifted or hoisted into a remote or inaccessible area, the support plate 51 includes an attachment point, such as a lifting eye rated for the weight of the generator with batteries. In an alternative construction, the support plate aperture 52 can accommodate the support pole of a wind turbine to augment the power harvesting reliability of the generator. The generators are constructed as stand-alone devices but may be linked to further devices to form an array.

FIGS. 10b and 10c are perspective elevations of hinge details of at least one framed panel 45 adapted to facilitate access to the interior of the enclosure illustrated in FIG. 10a.

A vertical pair of solar panels 45 are attached to a frame upright 41 by a 3D printed panel joint by a profiled pivot component 56 which is rotatably received in a clamp member 57 operably supporting the weight of the framed PV panel 45 and having a biasing mechanism therein to return the panel to its normally closed position where it may be latched shut. A magnetic latch mechanism, electrically operated by payment card verification, may be used to provide enhanced security. The pivot component 56 and clamp member 57 may be 3D printed or otherwise formed from a thermoplastic material such as TPU and have internal features to prevent rotation beyond the desired range of movement.

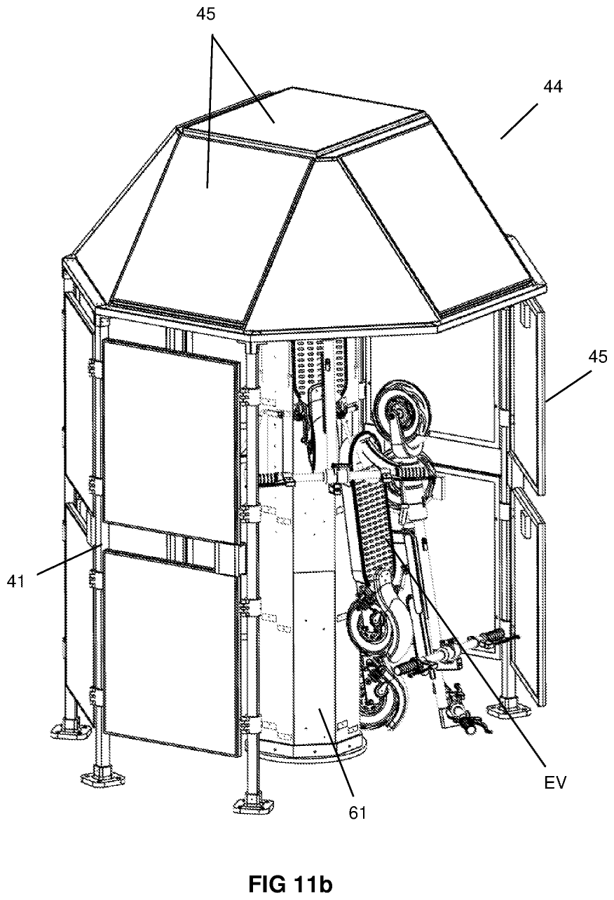

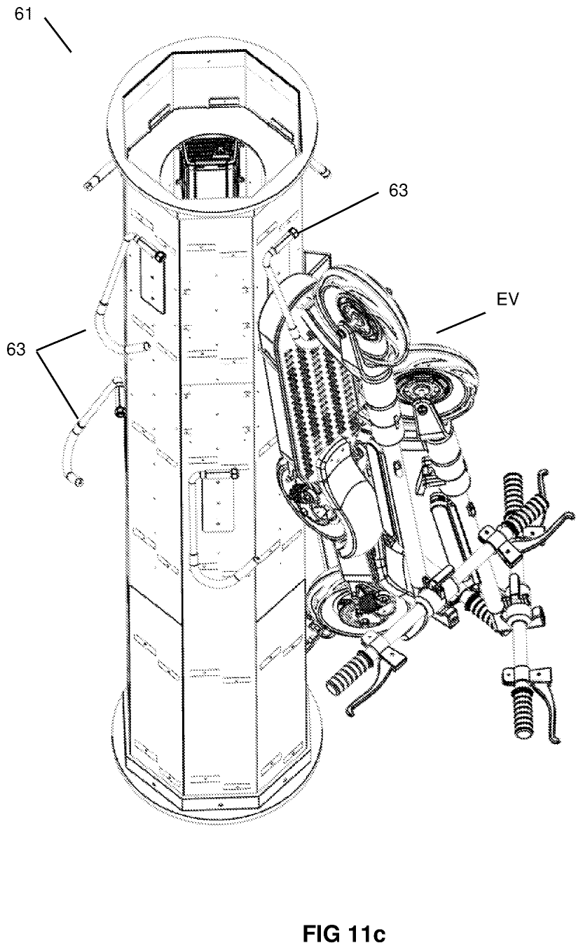

Finally, with reference to FIGS. 11a and 11b, a specific combination of the fourth embodiment 40 of the invention comprises a charging station 42, ideally for electric bikes and scooters EV. Similarly to the apparatus shown in FIG. 10a the charging station 42 comprises a self-supporting, ground-engaging framework of octagonal cross-section having upright frame elements 41, each being provided with an anchor plate 41a for securing the station to the ground. As before, PV panels 45 are secured between the upright elements, however, pairs of panels are latched on one side to provide an access door, utilising the mechanism described with reference to Figures 10b and 10c, to a centrally disposed charging column 61 to which or on which foldable electric scooters EV are attached for storage whilst charging. The upright frame elements 41 also provides support for a roof section 44 on which further PV panels 45 are arranged.

The central charging column 61, as detailed in FIG. 11 c, houses the battery banks WB, RB and charging regulators required for charging the electric scooters. RCD protected mains sockets are positioned one the central charging column for providing AC output for charge transformers. A communications module to facilitate card payment verification may also be integrated into the charging column. In a preferred arrangement, mounting hooks 63 are arranged at discrete heights around the charging column 61 to allow folded scooters EV to be stacked thereon providing maximum space internally for the geometries of a folded e scooter or other powered mobility device.

Ideally, a pocket is provided to house a user's own AC charger to guarantee compatibility with the widest range of e-scooters or other mobility devices.

It will be appreciated by the skilled reader that the above embodiment 40 is not limited to rectangular or octagonal cross-sections and that in certain circumstances other profiles including hexagonal and triangular may be preferred.

It will of course be understood that the invention is not limited to the specific details described herein, which are given by way of example only, and that various modifications and alterations are possible within the scope of the appended claims.

1. A photovoltaic (PV) charging station for charging electric vehicle (EV) batteries, the charging station comprising:
an enclosure having structural frame elements defining wall sections and a roof section, the enclosure having a ground-engaging element attached thereto; a plurality of PV panels secured to the frame elements;
sealingly disposed within the enclosure control circuitry for regulating the electrical energy generated via the PV panels and energy accumulators connected to the control circuitry; and
a charge coupling,
in which at least two of the PV panels are disposed in a vertical plane and comprise outward faces of the enclosure.

2. A charging station as claimed in claim 1, in which the PV panels are integrally formed with the frame elements.

3. (canceled)

4. A charging station as claimed in claim 1, in which the enclosure has a box-like form in which structural frame elements provide the peripheral corners thereof and the PV panels are secured therebetween.

5. A charging station as claimed in claim 1, claims, in which each wall section comprises a framed PV panel disposed in a vertical orientation presented as the outward facing surfaces of the enclosure, and in which the total surface area of PV panel being optimized to generate a daily average power output of at least 200 Wh.

6. (canceled)

7. A charging station as claimed in claim 1, in which the enclosure includes multiple receptacles for removable EV batteries, each receptacle having a charge coupling for connecting to the terminals of the EV battery.

8. A charging station as claimed in claim 1, in which the station is adapted to provide means for directly charging an electric vehicle (EV).

9. A charging station as claimed in claim 8, in which the charging station includes accommodation, securing or storage space within the enclosure or structure incorporating said enclosure for at least one EV.

10. A charging station as claimed in claim 9, in which the structure or enclosure is a building having a plurality of receiving bays for EVs.

11. A charging station as claimed in claim 8, in which the charging station includes mounting means for at least one EV.

12. A charging station as claimed in claim 1, in which the charging station includes a communications module and payment verification means.

13. (canceled)

14. A charging station as claimed in claim 1, in which the structural frame elements define an octagonal enclosure between which PV panels are disposed to present eight solar harvesting faces, at least one of the faces being hingedly secured to corresponding frame elements to facilitate access to the interior of the enclosure.

15. A charging station as claimed in claim 1, in which the energy accumulators comprise a bank of batteries having deep-cycle characteristics and a bank of batteries having high power delivery characteristics and wherein combining cell technologies with charge controllers and voltage monitoring circuitry optimises both charging and delivery of power in sub-optimal conditions.

16. A method of charging the battery of an electric vehicle (EV), the method including:
accessing a charging receptacle for the EV battery within the enclosure of a charging station of the type claimed in claim 1;
mounting the EV battery within the charging receptacle and aligning battery terminals of the battery to a charge coupling;
connecting a charge coupling to the EV battery terminals;
attending to a charging cycle; and
verifying the EV is ready for re-use.

17. A method of charging an electric vehicle (EV) battery, the method including:
accessing a mounting point for the EV within the enclosure of a charging station of the type claimed in claim 1;
mounting the EV to the mounting point;
coupling the EV to an electrical charging means;
attending to a charging cycle; and verifying the EV is ready for re-use.

18. A method of charging an EV battery as claimed in claim 17, in which the mounting point is elevated.

19. A method of charging an EV battery as claimed in claim 16, in which the charging cycle includes payment verification steps.

20. A method of charging an EV battery as claimed in claim 17, in which the method includes storing the EV.

21. A charging station as claimed in claim 1, the station having at least one major vertically disposed face, in which photovoltaic (PV) panels operably form at least the major faces of a structure or enclosure to optimise the harvesting of solar radiation in sub-optimal conditions with respect to diurnal and seasonal variances of direct and indirect incidence of solar radiation; and
in which each PV panel is attached to the structure or enclosure by a demountable frame adapted to encapsulate the PV panel and provide routing for cables associated with each panel.

22.-24. (canceled)

25. A charging station as claimed in claim 1, in which the frame elements comprise extruded profiled components having rebates and channels to accommodate and retain PV panels and associated cabling.

26. A charging station as claimed in claim 1, in which one or more frame elements releasably retain the PV panels and include hinge elements at their peripheries to facilitate access to the interior of the enclosure.

27. A charging station as claimed in claim 1, in which each face having a PV panel thereon has associated therewith a dedicated and appropriately rated charge controller to manage the solar power harvested from each panel within a face to maximise the efficiency of the charging output generated.

28. A charging station as claimed in claim 1, in which the energy accumulators comprise a storage cell array adapted to deliver a direct current (DC) power output to connected devices or a local power connector or via an inverter to provide an alternating current (AC) power output.

29. A charging station as claimed in claim 1, in which the structure or enclosure or structure incorporating the enclosure is adapted to receive, store and charge electric vehicles (EVs) from electric kick-scooters, electric motorcycles and electric cars, obviating the necessity of external or mains powered electrical connections.

30. A charging station as claimed in claim 1, in which the enclosure has an octagonal cross-section whereby framed PV panels are hinged to form access doors to a centrally disposed charging structure on which electric kick scooters are suspended for storage and charging.

31. A charging station as claimed in claim 1, in which the enclosure is open on one of its faces and in which at least one face of PV panels comprises an arrangement of formed PV panels in back-to-back configuration so as to receive indirect or reflected solar radiation within the open mouth of the enclosure and whereby EVs have access to charging facilities at the open mouth thereof.
